(19) United States
(12) Patent Application Publication
(10) Pub. No.: US 2014/0299200 A1
(43) Pub. Date: Oct. 9, 2014

(54) Liquid Condensate Collection and Drain Apparatus for Compressed Air-Gas Systems and Method Therefore

(71) Applicant: John Carlin, Buffalo, NY (US)

(72) Inventors: John Carlin, Buffalo, NY (US); Raymond Arno, Buffalo, NY (US)

(21) Appl. No.: 13/858,596

(22) Filed: Apr. 8, 2013

(51) Int. Cl. F16T 1/38

(52) U.S. Cl. CPC F16T 1/38
USPC 137/204

(57) ABSTRACT

The present invention provides a method, process and apparatus for effectively draining liquid condensate from compressed air/gas systems. The draining apparatus having a means to evacuate collected condensate from a chamber reservoir without a loss of system compressed air or gas in its discharge of the drainage to assure that contaminates and particulates in the liquid condensate do not collect and build-up in its inner chambers and orifices. The device reduces energy consumption as it relates to wasted compressed air/gas in the purging of liquid condensate.

This application claims the benefit of United States Provisional application of Raymond P. Arno and John A. Carlin, Ser. No. 61/621,153, filed 6 Apr. 2012, having the title LIQUID CONDENSATE COLLECTION AND DRAIN APPARATUS FOR COMPRESSED AIR/GAS SYSTEMS AND METHOD THEREFORE, which is incorporated herein by reference in its entirety.

### BACKGROUND

The present invention relates to the field of compressed air/gas systems, and more particular to the collection and drainage of liquid condensation from said systems in an efficient process without the loss of compressed air/gas.

In the field of industrial machinery, there exist a need for ‘dry’ air in the process of operating air/gas driven devices, product process and fabrication, etc., in countless applications and scenarios. Air and pressurized ‘compressed’ air in particular, is laden with moisture that negatively impacts its effectiveness in the above mentioned uses and processes; making costly equipment failure and ‘befouled’ product. ‘Holding Tanks’, ‘Filter Systems’, ‘Desiccant Dryers’, ‘Refrigerant Dryers’ and ‘Membrane Dryers’ are the prime methods, through the use of a drain device, that removes substantially the moisture, in the form of liquid condensation collected from air/gas for such industrial uses, thus reducing failures and improving product quality.

### Statement of the Problem

Moisture is a serious problem in compressed air systems. Compressors compress ambient air (in multiple stages) and the air is stored in holding tanks. Downstream from the holding tanks are a series of coalescing filters and compressed air/gas dryer systems; before going through a final stage filter and ready for use in a factory setting. At each of these stages, including the two or more stages within the air compressor itself, are opportunities to collect and drain-off considerable liquid condensation.

Since atmospheric air always contains some amount of moisture, measured in terms of relative humidity. Relative humidity is the ratio of moisture in the air compared to the capacity of moisture that volume of air is capable of holding at a specified temperature. When air is compressed, friction causes the actual air temperature to rise, greatly increasing its ability to hold moisture. At 100 PSIG the quantity of moisture commonly held in eight cubic feet of air is reduced in an area ⅛ its original size. The result of compression is hot, wet, dirty air and it is considered 100% saturated. A good general rule is that for every twenty degrees Fahrenheit (20° F.) the temperature of air decreases, its ability to hold moisture is reduced by 50%. As air passes through a plant piping system, the ambient conditions cause the compressed air to cool, causing the formation of liquid water. This water, coupled with particulate matter and oil/lubricant carry-over will cause numerous problems. The water will wash away lubricants from tools and machinery, spoil paint applications, rust the general system, and, if exposed to unfavorable ambient temperatures, freeze. Further particulate matter consists of atmospheric particles that are drawn into a plant piping system through the air compressor intake are present in the resulting liquid condensation. Such particulate matter will clog orifices, valves and equipment.

Drain devices afford a means to remove the build-up of collected liquid at every stage of the compressed air/gas system. There are several types of drain devices employed today. They range from electronic to pneumatic to no-air-loss to timed drains. They use floats, sensors, detectors, magnets, switches and mechanical means, etc., to perceive the presence of liquid condensation and jettison it out of the drain reservoir as drainage. Without drain systems at every stage (the compressor, the holding tank, the coalescing sump, the coalescing filter and the compressed air dryer system), there would be no expectation for dry air/gas at the end stage for industrial use as dry compressed air/gas.

Part of the problem with current drain devices stems from the excessive amount of compressed air/gas lost in the purging of its collection reservoir, of the collected liquid condensation—such air/gas loss is significant in terms of operating cost. Another problem is mechanical failure due in part to the contaminants in the condensation fouling orifices in valves and other mechanisms in the drain device assembly itself, resulting in high maintenance expenses. And yet, another problem is that many drain devices must operate at dangerously high pressures; making safety an issue.

An example of just the air loss issue alone, where if just a single drain device would allow compressed air/gas to escape for a measly two seconds beyond the purging of liquid condensation, would equate to an operating loss of $177 per year. (The dollar amount is based on a formula using a compressed air system of 100 PSIG with an operating cost of $0.10 per kW (1 hp per 5 SCFM), and a drain valve orifice of ¼ inch. The drain operation of just 2 seconds beyond purging liquid condensation every 20 minutes, 24 hours a day.) If the valve orifice was larger, say ⅜ inch (instead of ¼ inch), the operating loss would increase to $399 dollars a year, and a ½ inch valve orifice would equate to $710 annually. If the drain where to operate for just one second longer, to 3 seconds (instead of 2 second), the cost losses would be $266, $599 and $1,064 for each of the valve orifice sizes of ¼ inch, ⅜ inch and ½ inch respectively. And this example is just one singular drain device. A modest 100 or 200 CFM compressed air system, end to end would employ 3 to 4 independent drain devices. A 10,000 or 20,000 CFM compressed air system certainly would encompass many time that more, drain devices, and they would be operating more frequently then in the example above.

With respect to contaminants in the condensation fouling orifices in valves and other mechanisms, conventional drain systems need to keep the orifices and valves small, to insure that excessive air loss does not happen, and consequently the drain devices are subject to high failure due to fouling. In the case of high pressure drain systems, for example many PET (polyethylene terephthalate) used in the manufacturing of plastic containers/bottles, drains need to be suitable for pressures operating at 300 PSI, 700 PSI, 1000 PSI or even higher. Such high pressure drain systems are markedly more expensive to be safe and they may be more prone to mechanical issues.

### Solution to the Problem

Having a compressed air/gas drain device that would allow for large diameter orifices and valves (literally up to any practical diameter, for example 1 inch) and have no (or substantially none) air loss, which will effectively eliminate the negative effects prevalent in prior art, as high cost operating losses due to escaping compressed air down the drain, and, high failure and required maintenance due to fouling. Further an improved system that would be safe in high pressure applications and still be of a standard construction without costly over-design to handle the extreme pressures.

The present patent provides structure to effect a more efficient means to drain collected liquid condensation in the reservoir of a drain device. The result of this unique approach, reduces the operating losses so prevalent in the compressed air/gas industry, substantially eliminates nuisance maintenance due to drain fouling, and, allows for high pressure installations without any extraordinary considerations for high pressure. Further, the undesirable effects from complex designs using floats, sensors, magnets, switches, pneumatic balance members and the like, all subject to breakdown, is reduced or eliminated, making the purging of collect liquid condensation in a drain reservoir, simple, safe and cost effective.

### DISCUSSION OF PRIOR ART

Prior to the filing of this application, the subject inventors conducted a patentability investigation in the field of compressed air drains and related systems. The following patents were uncovered in the search.

| Inventor | Reg. No. | Date |
|---|---|---|
| Sinstedten | 7,699,238 | Apr. 20, 2010 |
| Schlensker, et al | 6,588,443 | Jul. 8, 2003 |
| Koch | 6,276,894 | Aug. 21, 2001 |
| Koch, et al. | 6,206,025 | May 27, 2001 |
| Love | 6,196,253 | May 6, 2001 |
| Loutzenhiser | 5,749,391 | May 12, 1998 |
| Page | 5,655,570 | Aug. 12, 1997 |
| Rasmussen | 5,531,241 | Jul. 2, 1996 |
| Rasmussen | 5,469,879 | Nov. 28, 1995 |
| Cummings, et al. | 4,444,217 | Apr. 24, 1984 |
| Cattani | 4,293,300 | Oct. 6, 1981 |
| Bridges | 4,261,382 | Apr. 14, 1981 |

Sinstedten—In the U.S. Pat. No. 7,699,238 has a stream trap collecting chamber for draining-off condensate. The device may operate in a negative pressure, overpressure or an atmospheric pressure. Said system has an interface first assembly unit and a maintenance assembly unit which comprise the essential wear and tear parts.

Schlensker, et al—U.S. Pat. No. 6,588,443 uses a reservoir to collect condensation, a fill level meter means, a control pressure which is above the pressure in the reservoir and an exhaust valve to drain the condensation collected.

Koch—In U.S. Pat. No. 6,276,894 having a method for draining collected condensation in a collection chamber when a at least one electronic sensor detects the presents of condensation and a purging valve at the outlet, the purging valve using a timer circuit to close when sensor indicates no condensation.

Koch, et al.—U.S. Pat. No. 6,206,025 has a tubular body located inside the collector vessel. The tubular body has an electronic sensor (preferably a capacitive sensor) which is capable of functioning as a control for an external valve to drain condensation.

Love—U.S. Pat. No. 6,196,253 is a continuously operated drain valve that has a subminiature sensor embedded in the valve. The drain valve will operate in real-time and can operate at an extremely high cycle rate when condensation is present.

Loutzenhiser—U.S. Pat. No. 5,749,391 is a condensate drainage system for pneumatic tanks for vehicles, having a logic controller with programmable memory and a timer. The system purges condensate automatically or by an override pushbutton.

Page—U.S. Pat. No. 5,655,570 is a condensate drain device suitable for high pressure. The device uses a wicking disk to remove condensation from the system without significant reduction in pressure and has no moving parts.

Rasmussen—U.S. Pat. No. 5,531,241 shows a condensation removal device that measures and purges condensation only on demand. A differential pressure sensor senses when the collecting reservoir need empting by means of a diaphragm type discharge valve.

Rasmussen—U.S. Pat. No. 5,469,879 is a condensation removal device having a single sensing probe in the collection reservoir sensing high and low levels and activating a diaphragm type discharge valve to empty reservoir.

Cummings, et al.—In U.S. Pat. No. 4,444,217 we see an automatic drain system with a reservoir to collect water condensables and other foreign materials, a float, a pair of magnetically coupled magnets, a pilot valve and a drain valve is disclosed. When the float reaches its upper most position, the magnet system causes the pilot valve to move and the drain valve is rapidly opened permitting a complete draining within the reservoir (including contaminants accumulated) where upon the pilot valve moves back and the drain valve closes.

Cattani—U.S. Pat. No. 4,293,300 discloses a liquid separating and evacuating device for dental surgery equipment that continuously drain liquid without interrupting the suction and allows liquid to pass to the outside.

Bridges—U.S. Pat. No. 4,261,382 shows an electronically operated condensation drain valve with at least one sensor element to trigger the electronic circuit to operate the valve. The system may employ two temperature sensors to indicate high and low levels of condensation. The system also uses a delay means to timing.

None of the above approaches discloses a means for allowing large diameter orifices and valves. Also none of the listed prior art can leave the outlet discharge valve open, for laterally any given time duration, and still have no (or substantially none) air loss. And further, none of the devices above can be of standard construction, but still allowing safe operation in high pressure installation without costly over-design to handle the extremes of high pressure The compressed air/gas drain devices disclosed above all have problematic and complex sensors, floats, detectors, magnets or are of intricate mechanical design that is subject to failure and high maintenance due to fouling of their mechanisms. Finally, none of the prior art addresses the cost saving in terms of energy and downtime as it related to an efficient means of operating a reliable compressed air/gas liquid condensate drain apparatus.

### SUMMARY OF THE INVENTION

An object of the present invention is an improved liquid condensation drain apparatus for compressed air/gas systems. An apparatus having a means to evacuate collected condensation from a chamber without a substantial loss of system compress air or gas in its discharge of drainage.

Another object of the present invention is to insure that contaminates in the liquid condensation do not collect in its inner chambers and orifices, that would lead to fouling over time and cause failure and high maintenance.

Still another object of the present invention is to reduce energy consumption as it relates to wasted compressed air/gas in the purging of condensation.

Yet another objective of the present invention is to reduce or eliminate the danger and construction expense as it relates to high pressure drain devices.

Another objective of the present invention is to increase safety relates to high pressure drain devices.

Finally, another objective of the present invention is to save cost in operation. Operating cost can be substantial over the drain life totaling potentially into the multiple thousands of dollars, and in a full compressed air/gas manufacturing setting of several individual drain devices comprising a typical compressed air/gas system, could well be a cost saving into the tens of thousands of dollars.

The present invention takes advantage of all these objectives by not allowing compressed air/gas to escape down the drain in the process, by insuring that drain fouling does not create high maintenance requirements, and, a devices of conventional construction in a high pressure installation without over-design to handle the extreme pressures. The disadvantages listed earlier are all overcome and the liquid condensation drain device of the present invention, uniquely solves problems that prior art cannot.

### REFERENCES

### Present Invention

10a FLOW DIAGRAM OF THE PREFERRED EMBODIMENT
10b FLOW DIAGRAM OF FIRST ALTERNATE EMBODIMENT
10c FLOW DIAGRAM OF SECOND ALTERNATE EMBODIMENT
12 CHAMBER HOUSING
14 RESERVOIR
16 INLET PORT
18 OUTLET PORT
20 INSPECTION PORT
22 FORTH PORT
24 ‘normally open’ INLET SOLENOID VALVE
26 ‘normally closed’ OUTLET PORT
28 PRESSURE REGULATOR
30 INTEGRAL PRESSURE GAUGE
32 PRESSURE ADJUSTMENT MEANS
34 CONDENSATION DEVICE ENTRY CONNECTION
36 CONDENSATION DEVICE DISCHARGE CONNECTION
38 FIXED REDUCING PRESSURE REGULATOR
S UNIVERSAL SHELL
40 THREADED UPPER PORT
42 THREADED LOWER PORT
44 COUPLING HOLES
46 BLIND MOUNTING HOLES
48 FLAT SURFACE
50 INNER SPACE (comprising half reservoir 14a)
52 O-RING GROOVE
54 ACCESS HOLE (upper)
56 ACCESS HOLE (lower)
58 BOLT (coupling)
60 NUT (coupling)
62 MOUNTING BRACKET
64 BOLT (blind hole)
66 HOLE (mounting bracket)
68 PLUG (port)
70 O-RING
A CROSS SECTIONAL REFERENCE (see FIG. 6)
72 LIQUID CONDENSATE LEVEL
74 ULLAGE SPACE (above the level 72)
76 COLLECTED LIQUID CONDENSATION
78 LIQUID CONDENSATE TRICKLE-IN
12a CHAMBER HOUSING (mechanical representation)
14a RESERVOIR (mechanical representation)
16a INLET PORT (mechanical representation)
18a OUTLET PORT (mechanical representation)
20a INSPECTION PORT (mechanical representation)
22a FORTH PORT (mechanical representation)
24a ‘normally open’ INLET SOLENOID VALVE (mechanical representation)
26a ‘normally closed’ OUTLET PORT (mechanical representation)
28a PRESSURE REGULATOR (mechanical representation)
30a INTEGRAL PRESSURE GAUGE (mechanical representation)
32a PRESSURE ADJUSTMENT MEANS (mechanical representation)
34a CONDENSATION DEVICE ENTRY CONNECTION (mechanical representation)
36a CONDENSATION DEVICE DISCHARGE CONNECTION (mechanical representation)

### BRIEF DESCRIPTION OF THE DRAWINGS

FIG. 1a is a flow diagram of the preferred embodiment of the present invention;

FIG. 1b is a flow diagram of an alternate embodiment of the present invention;

FIG. 1c is a flow diagram of another alternate embodiment of the present invention;

FIG. 2a is a perspective view showing the outside of the drain chamber universal shell;

FIG. 2b is a perspective view showing the inside of the drain chamber universal shell;

FIG. 3 is a top plainer view of the preferred embodiment in the flow diagram of FIG. 1a showing the input and output ports and one possible mounting pattern;

FIG. 4 is a front plainer view of the device in FIG. 3 showing additional device ports;

FIG. 5 is an side perspective view of the preferred embodiment of FIGS. 3 and 4;

FIG. 6 is an illustration of the present invention of FIG. 5 showing in an exploded view; and

FIG. 7 is an illustration of FIG. 6 showing a cross sectional view ‘A’ of the main body housing.

### DETAIL DESCRIPTION OF THE INVENTION

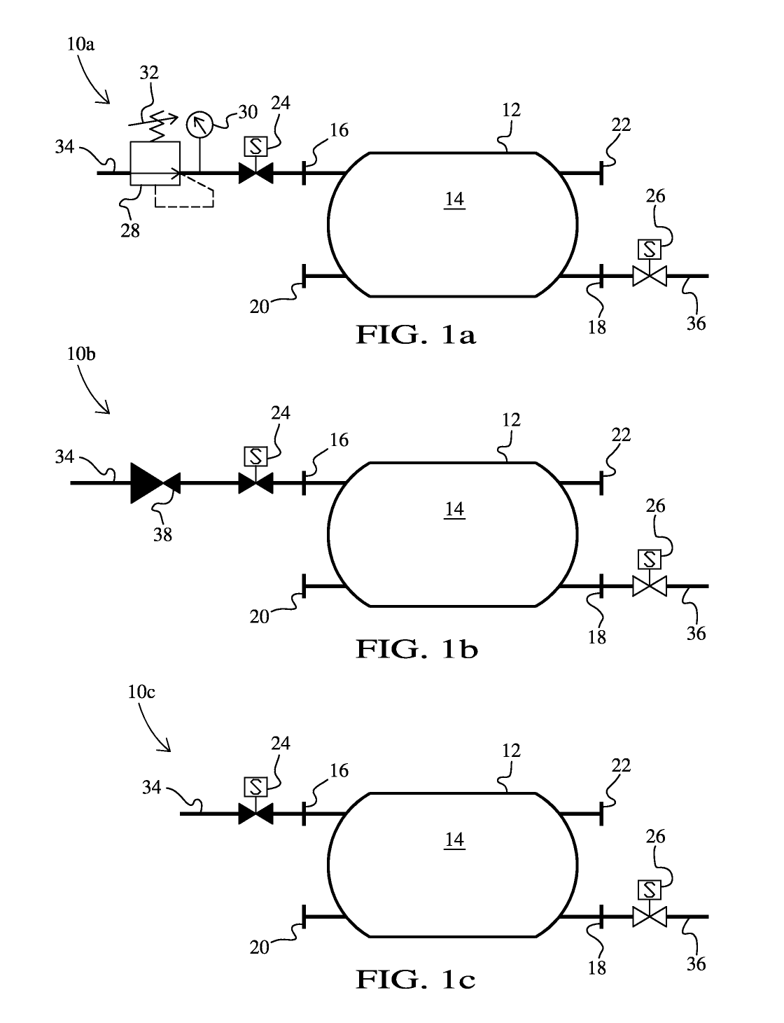

In FIG. 1a is shown a flow diagram 10a of the preferred embodiment of the present invention having a chamber housing 12 with a reservoir 14, an inlet port 16 and an outlet port 18. The chamber housing 12 further has an inspection port 20 and a forth port 22. Mounted to the chamber housing 12 inlet port 16 is a normally open inlet solenoid valve 24 and to the outlet port 18, a normally closed outlet solenoid valve 26. Further mounted to the inlet solenoid valve 24 is a pressure regulator 28 with an integral pressure gauge 30 and a pressure adjustment means 32. Finally, a condensation entry device connection 34 and a collected condensation discharge device connection 36.

Condensation would enter the drain system (illustrated in the flow diagram 10a) at the device connection 34 and pass through the pressure regulator 28. The condensation would continue through the normally open solenoid valve 24 and into the inlet port 16. The condensation would collect within the reservoir 14 of the chamber housing 12. At an appropriate time (as will be discussed later), the normally closed outlet solenoid valve would open and allow any collected condensation within the reservoir to discharge through the outlet port 18, solenoid valve 26 and discharge out the device connection 36 for drainage. It is important to understand that the when the normally closed outlet solenoid valve 26 is energized open (allowing flow through it), the normally open inlet solenoid valve 24 is energized to close (blocking flow through it). There would be a small pressurized ‘air/gas’ ullage space above the collect condensate within the reservoir 14 (this will be more fully disclosed later), that when the outlet is discharged, the condensate would flow freely out. Again it is important to understand that since no additional compressed air/gas can reenter the chamber 12, because the inlet solenoid valve 24 is energized to the closed position, the outlet solenoid valve 26 can be left open for drainage as long as is desired with no air loss.

Referring back to the pressure regulator 28, in this embodiment of the present invention, has an adjustment means 32 to step-down the compressed air/gas system pressure (for example 100 PSIG), to a drain device operating pressure (for example 30 PSIG), as set on the integral pressure gauge 30. The drain device of the flow diagram 10a can be set to any pressure for use. The 100/30 ratio in the above example would represent a typical compressed air installation. But the adjustment 32 could just as easily be set to have drain operating pressure of 60 PSIG or 20 PSIG. Further, in the case of a ‘high pressure’ installation, where pressures could be 300, 700 or even a 1000 PSIG at the device connection 34, the drain operating pressure could still be within a low safe range, for example under 100 PSIG. The usage of the inspection port 20 and the forth port 22 will be discussed later in the patent.

We move now to the first alternate embodiment of FIG. 1b, where is shown a flow diagram 10b. In this embodiment, is used a fixed reducing pressure regulator 38. The fixed reducing regulator 38 could be, for example, one with a ratio of 100 PSIG to 30 PSIG. And, will not have any adjustment means or pressure display means (32 or 30 respectively) as in the system of the flow diagram 10a device above. All other aspects of operation of the first alternate embodiment in flow diagram 10b work similarly as was disclosed in the flow diagram 10a of FIG. 1a above. It is important to understand that any ratio of pressure reduction, as would be suitable for any given drain device installation, could be used by selecting a pressure reduction regulator as manufactured for such pressure reduction (for example 1000 to 60 PSIG).

Moving now to the second alternate embodiment of FIG. 1c, where is shown a flow diagram 10c. In this embodiment, the use any pressure regulating means has been eliminated. That is, adjustable pressure regulator 28 and fixed reduction pressure regulator 38 are not present in the device, and will accept whatever line pressure is present on the compressed air/gas system it is connected to at the condensation device entry connection 34. Again, all other aspects of operation of the second alternate embodiment in flow diagram 10c work similarly as was disclosed in the flow diagram 10a of FIG. 1a above. In this configuration, the device of the flow diagram 10c, operating at a higher pressure for example 100 PSIG, the device would need the consideration for such pressure, but will function suitably and safely. More on this subject will be disclosed later.

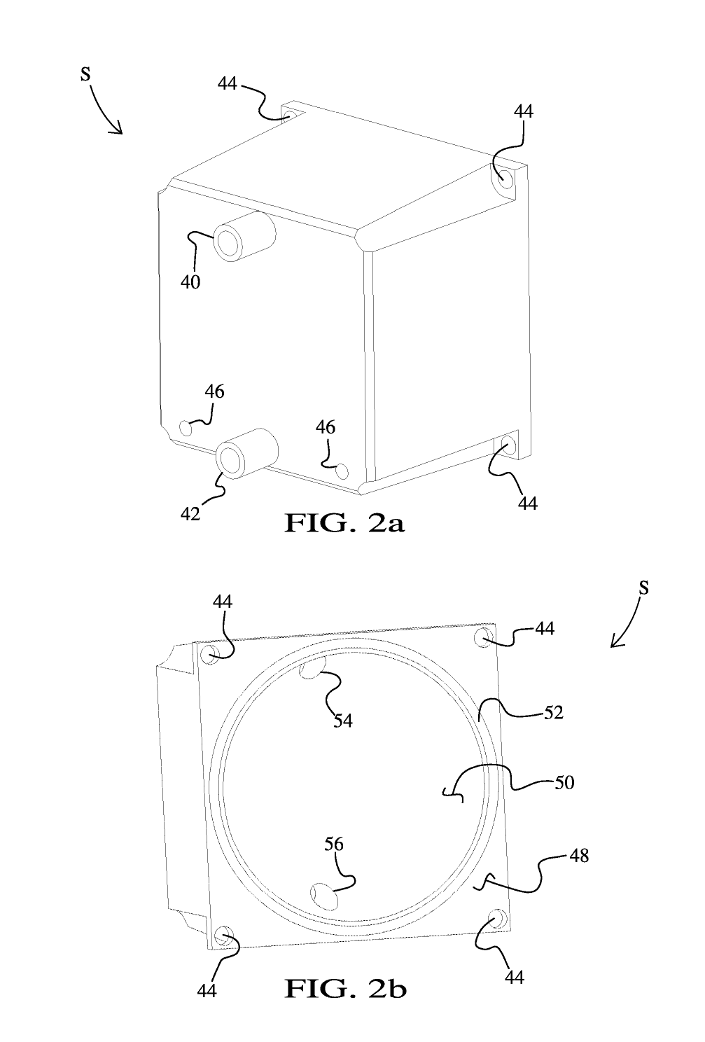

FIG. 2a is a perspective view showing the outside of the drain chamber universal shell S. The shell S has a threaded upper port 40 and a threaded lower port 42, a coupling hole 44 on each corner and a blind mounting hole 46 on the bottom two ends. The ports 40 and 42 can be threaded either on the inside or outside making them either female or male connections, as may be desired in manufacturing. The preferred embodiment is ½ inch NPT female. The blind mounting holes 46 have female threads that is ¼ inch NPT female. The shell is of molded construction of high strength, fiber filled nylon polymer. (such as DuPont's ST801).

FIG. 2b is a perspective view showing the inside of the drain chamber universal shell S having a flat surface 48, an O-ring groove 52, and inner space 50, with an access holes 54 and 56 joined to the ports 40 and 42 respectively in FIG. 2a. To make a complete chamber, two identical universal shells S are assembled with their flat surfaces 48 mated to one another, and with an O-ring inserted into the O-ring groove 52. The unit then would be secured by nut & blots used in each of the four coupling holes 44. The preferred embodiment of the present invention, the shell is of fiber filled nylon polymers as stated above, but could be constructed with any other suitable material such as aluminum cast, or, even welded carbon or stainless steel to form a chamber/reservoir. In any case, a bust value for a pressure test would be expect to be between 1400 to 1600 PSI, and a normal operating pressure of 150 to 200 PSI. More will be disclosed on the construction of the chamber 12 in the later figures of the present patent.

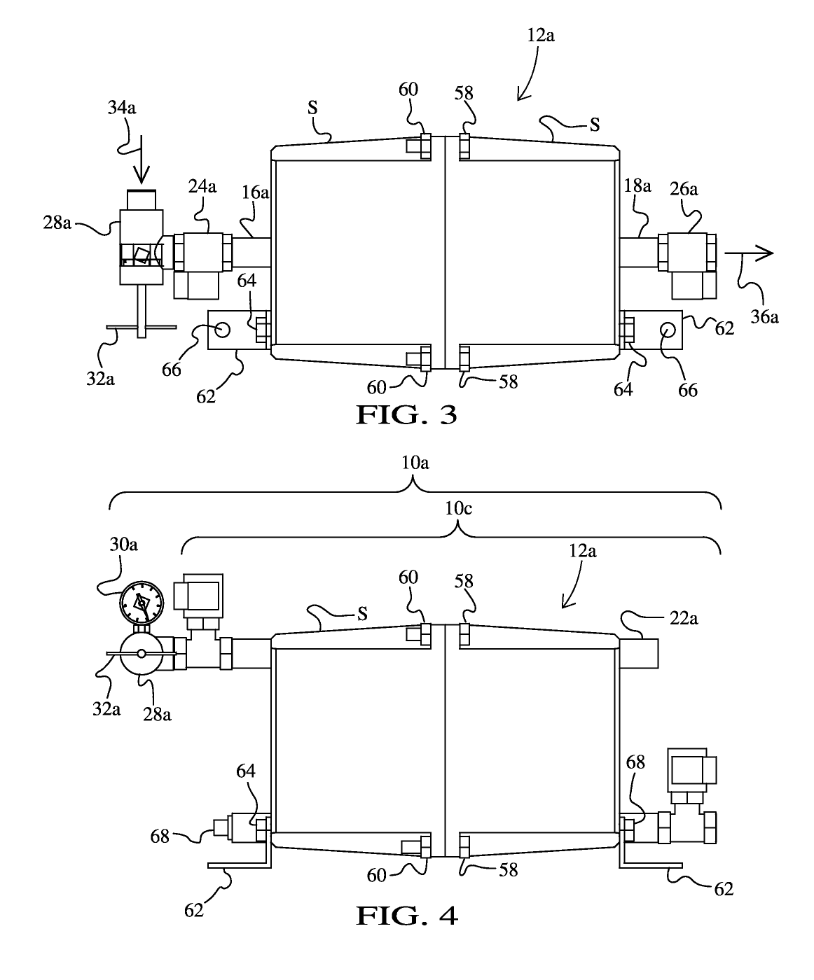

FIG. 3 is a top plainer view of the preferred embodiment in the flow diagram of FIG. 1a, showing the input port 16 and output port 18 as mechanical representations 16a and 18a respectively. Two universal shells S are joined together and secured with a bolt 58 and a nut 60 at each of the four corners. The drain device can be mounted to equipment via a mounting bracket 62 that is attached to each shell S with a bolt 64 (that mates with blind holes 46). In the preferred embodiment bolts 58 and 64, and nuts 60 are all ¼ inch NPT. A hole 66 in the mounting bracket 62 is suitable for mounting the drain device, either horizontal or vertical, to the external compressed air/gas equipment.

The mechanical representations of the flow diagram symbols of FIG. 1a inlet solenoid valve 24, the outlet solenoid valve 26, pressure regulator 28 (with adjustment means 32 and pressure gauge 30), condensation entry device connection 34 and condensation discharge connection 36 are indicated in FIGS. 3 as 24a, 26a, 28a, 30a, 32a, 34a, and 36a respectively.

FIG. 4 is a front plainer view of the device in FIG. 3 showing additional device ports 20a and 22a. 20a and 22a are mechanical representations of the flow diagram symbols of FIG. 1a inspection port 20 and forth port 22. The inspection port 20a has a plug 68 inserted to close off the opening. The plug 68 may be removed from time to time to inspect for build-up on sediment and slug that may be deposited after extended period of use from the condensate. The forth port 22a may be used for a number of optional functions. One such function is to use forth port 22a as a vent for pressure equalization (not shown for clarity of presentation). Another possible function could be as a means for instrumentation (pressure and temperature) or sensors such as a level sensor, also not shown. If no optional feature is used, the forth port 22a would be plugged-off as is plug 68 on the inspection port 20.

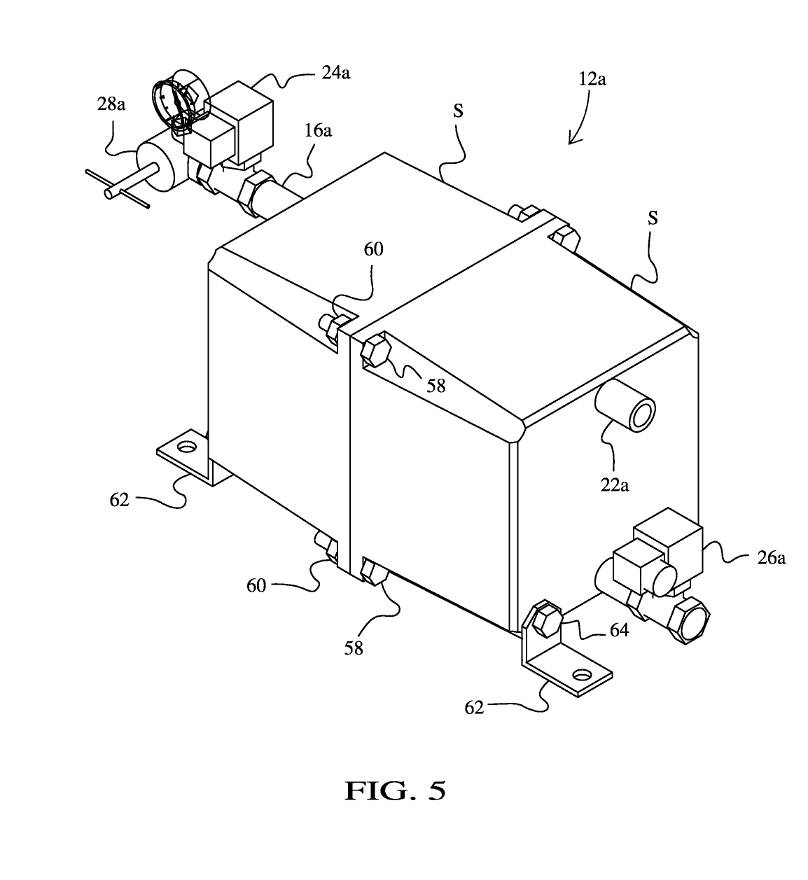

FIG. 5 is a side perspective view of the preferred embodiment of FIGS. 3 and 4 showing all the components fully assembled.

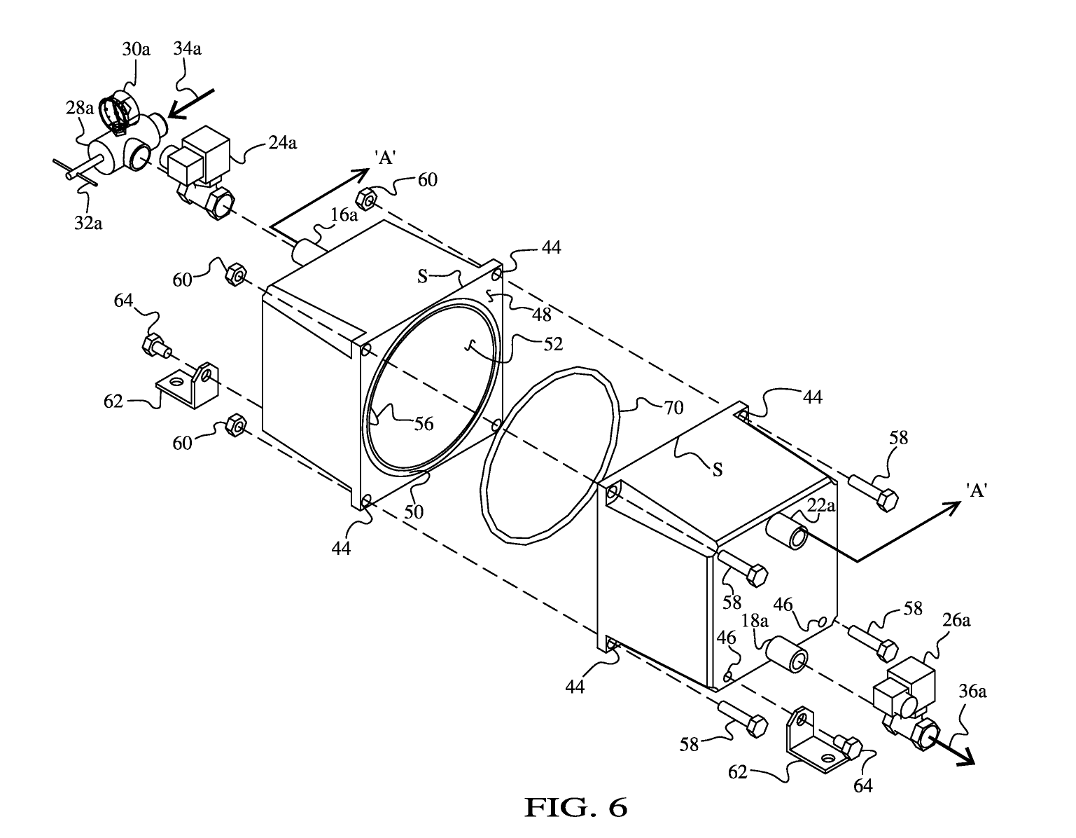

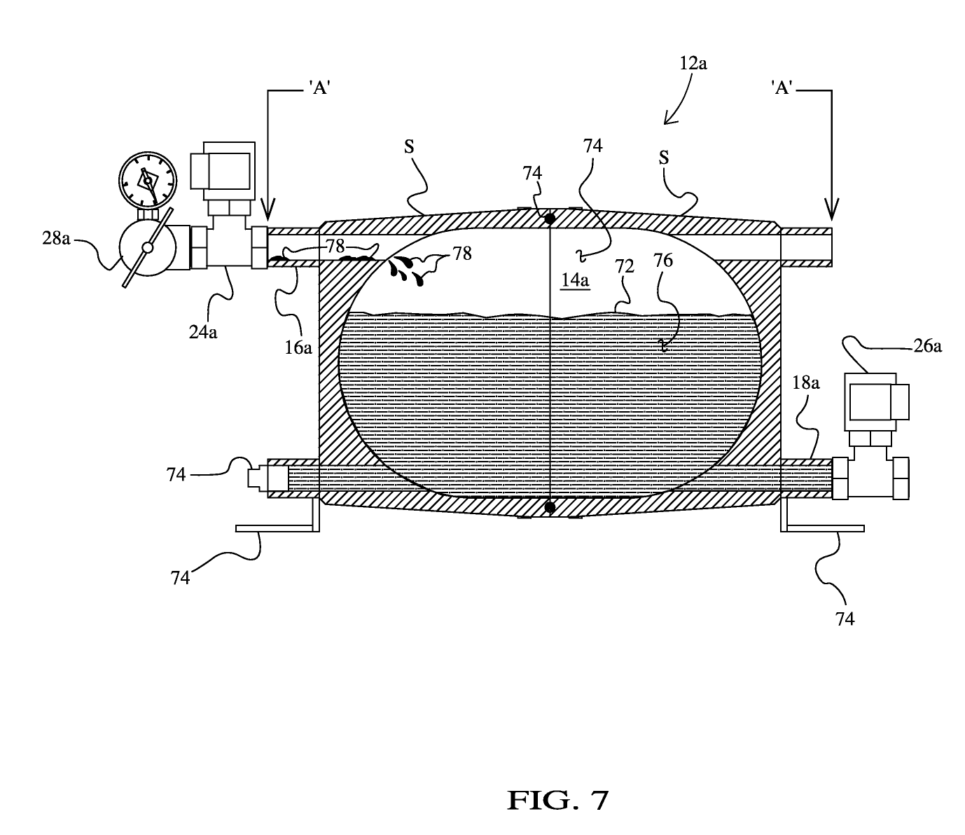

FIG. 6 is an illustration of the present invention of FIG. 5 showing in an exploded view with each component separated and dashed line indicating their relationship to one another. An O-ring 70 is shown how it would be seated in the groove 52 of flat surface 48 in the universal shells S. The reference ‘A’ indicate where the cross sectional view is located in the up-coming FIG. 7.

FIG. 7 is an illustration of FIG. 6 showing a cross sectional view ‘A’ of the main body housing. The O-ring 70 properly seated creates a pressure-tight vessel chamber 12a with a reservoir 14a (12a and 14a are mechanical representations of the chamber 12 and reservoir 14 symbols, respectively, illustrated in FIG. 1.) The reservoir 14a has a liquid level 72, and ullage space 74 and a liquid space 76. Liquid condensate 78 trickle-in to the reservoir 14a, as was described earlier, through pressure regulator 28a, inlet solenoid valve 24a and inlet port 16a. When level 72 rises over time, for example fifteen or twenty minutes, the normally open inlet solenoid valve CLOSES (isolating the drain system from the upstream line pressure) and the normally closed outlet solenoid valve OPENS when they are energized.

The energizing of these solenoids are accomplished by an electric timing device (such as a programmable logic controller or discrete electronic device designed for such timing) not shown because they are of conventional means and are common.

In operation, when the inlet and outlet solenoids are both energized, the collected condensation 76 in the reservoir 14a, is jettisoned out through outlet port 18a and outlet solenoid 26a and discharged down a disposal drain as drainage. Because the inlet solenoid valve is closed, there is no loss of precious compressed air/gas, ever, and the outlet solenoid can be left OPEN as long as necessary to fully empty the reservoir. It is important to understand that the residual compressed air/gas, in the ullage space 74 will help propel the liquid condensation out the system because of the differential pressure between the ullage space and ambient pressure of the deposal drain. Since there is no loss of precious compressed air/gas, ever, the inlet and outlet solenoid valves can be larger in orifice size; allowing complete expulsion of particulates and contaminates in the condensation avoiding sediment build-up in the reservoir the leads to expensive device malfunction and high maintenance, as is common in prior art drain devices. However, the inspection port 20a affords easy viewing the reservoir bottom, at maintenance intervals, and, should it every be necessary to open the chamber 12a, the system can be fully disassembled and re-assembled (by simply removing the four coupling bolts 58 and nuts 60).

While the invention has been particularly described and illustrated in detail with reference to the preferred embodiment and two alternate embodiments, it should be understood by those skilled in the art that equivalent changes in form and detail may be made without departing from the true spirit and scope of the invention as claimed, except as precluded by the prior art. The embodiments of the invention for which an exclusive privilege and property right is clamed are defined as follows:

What is claimed is:

1. A system process and apparatus for draining liquid condensate from compressed air/gas systems comprising:
a means to collect liquid condensate to a chamber/reservoir and evacuate the same in discharging with no-loss of compressed air/gas;
said collection means having at least one inlet port for liquid condensate to enter chamber/reservoir and at least one outlet port for the discharging of liquid condensate from the chamber/reservoir housing;
means to reduce line pressure from the entry of the drain device to chamber/reservoir operating pressure;
said reduce line pressure means having adjustment capability to set any desired reduction of line pressure to drain device operation pressure;
means to inspect inner chamber reservoir and a means to optionally vent inner chamber reservoir or insert instrumentation into inner chamber reservoir;
said inspection, venting or instrumentation means having addition ports accessible on the chamber/reservoir housing;
wherein, said liquid condensate freely trickles through the inlet port into collection chamber/reservoir, where it is at a reduced pressure, and, at a suitable interval will evacuate any collected liquid condensate at the outlet port by discharging as drainage, where said discharging of drainage would carry substantially all contaminates, particulates and slug present in the condensate, out of the drain device.

2. The no-loss of compressed air/gas while discharging liquid condensate system and method of claim 1, wherein said chamber/reservoir means is isolated from upstream line pressure during an evacuation.

3. The isolated means of the chamber/reservoir from upstream compressed air/gas pressure of claim 2, is an inlet normally OPEN solenoid valve disposed on a chamber housing inlet port.

4. The discharging liquid condensate means from the chamber/reservoir of claim 2, is an outlet normally CLOSED solenoid valve disposed on a chamber housing outlet port.

5. The reduce line pressure means and method of claim 1, is a pressure regulator.

6. Said pressure regulator means of claim 5, is an adjustable pressure regulating device.

7. Said pressure regulator means of claim 5, is a fixed reduction pressure regulating device.

8. A system process and apparatus for draining liquid condensate from compressed air/gas systems comprising:
a means to collect liquid condensate to a chamber/reservoir and evacuate the same in discharging with no-loss of compressed air/gas;
said collection means having at least one inlet port for liquid condensate to enter chamber/reservoir and at least one outlet port for the discharging of liquid condensate from the chamber/reservoir housing;
means to reduce line pressure from the entry of the drain device to chamber/reservoir operating pressure;
said reduce line pressure means having adjustment capability to set any desired reduction of line pressure to drain device operation pressure;
means to inspect inner chamber reservoir and a means to optionally vent inner chamber reservoir or insert instrumentation into inner chamber reservoir;
said inspection, venting or instrumentation means having addition ports accessible on the chamber/reservoir housing;
wherein, said chamber/reservoir housing is of molded construction for liquid condensate to freely trickle through the inlet port into collection chamber/reservoir,
where it is at a reduced pressure, and, at a suitable interval will evacuate any collected liquid condensate at the outlet port by discharging as drainage, where said discharging of drainage would carry substantially all contaminates, particulates and slug present in the condensate, out of the drain device.

9. The molded construction of the chamber/reservoir housing of claim 8, is comprised of high strength molded polymers.

10. The molded construction of the chamber/reservoir housing of claim 8, is comprised of aluminum casting.

11. The isolated means of the chamber/reservoir from upstream compressed air/gas pressure, and, the discharging liquid condensate means from the chamber/reservoir of claim 8, is an inlet normally OPEN solenoid valve disposed on a chamber housing inlet port, and an outlet normally CLOSED solenoid valve disposed on a chamber housing outlet port; both operating at the same time when energized.

12. The reduce line pressure means and method of claim 8, is a pressure regulator variably set to reduce line pressure down to 30 PSIG for the chamber reservoir.

13. Said pressure regulator means of claim 8, is a fixed reduction regulator regulating device reducing line pressure down to 30 PSIG for the chamber reservoir.

14. The no-loss of compressed air/gas means of claim 8, is the simultaneous operation of inlet and outlet solenoid valves.

15. A system process and apparatus for draining liquid condensate from compressed air/gas systems comprising:
a means to collect liquid condensate to a chamber/reservoir in a molded housing and evacuate the same in discharging with no-loss of compressed air/gas from the upstream line pressure;
said collection means having an inlet port disposed to the housing for liquid condensate to enter chamber/reservoir and an outlet port for the discharging of liquid condensate from the chamber/reservoir housing;
means to reduce line pressure from the entry of the drain device to the inner chamber/reservoir operating pressure;
said reduce line pressure means having adjustment regulator to set any desired reduction of line pressure to drain device operation pressure;
means to inspect inner chamber reservoir by accessing an inspection port on the chamber housing, and, a means to optionally vent inner chamber reservoir;
said inspection, venting or instrumentation means having addition ports accessible on the chamber/reservoir housing;
wherein, said chamber/reservoir housing is of molded construction of high strength, fiber-filled polymers or aluminum casting, for liquid condensate freely to trickle through the integral inlet port into collection chamber/reservoir, where it is at a reduced pressure, and, at a suitable interval will evacuate any collected liquid condensate at the integral outlet port by discharging as drainage, where said discharging of drainage would carry substantially all contaminates, particulates and slug present in the condensate, out of the drain device.

16. The molded construction of the chamber/reservoir housing of claim 15, is comprised of high strength molded polymers, O-ring and assembly suitable for compressed air applications.

17. The molded construction of the chamber/reservoir housing of claim 15, is comprised of aluminum casting, O-ring and assembly suitable for compressed air applications.

18. The isolated means of the chamber/reservoir from upstream compressed air/gas pressure, and, the discharging liquid condensate means from the chamber/reservoir of claim 15, is an inlet normally OPEN solenoid valve disposed on a chamber housing inlet port, and, an outlet normally CLOSED solenoid valve disposed on a chamber housing outlet port; both operating at the same time when energized to allow the collected liquid condensate to evacuate without any loss of compressed air/gas from upstream line pressure, for the drain device;
Said inlet normally OPEN solenoid valve and outlet normally CLOSED solenoid valve having large orifices to allow complete evacuation of any contaminates or particulates or slug that may be present in the liquid condensate.

19. The reduce line pressure means and method of claim 15, is a pressure regulator variably set so that the compressed air/gas system line pressure is reduced to 30 PSIG for a safer operating pressure of the drain device.

20. The no-loss of compressed air/gas means of claim 15, is the simultaneous operation of inlet and outlet solenoid valves, closing the normally OPEN inlet and opening the normally CLOSED outlet solenoid valve, completely isolating the compressed air/gas line operating pressure from the ambient pressure outside of the drain device, resulting in never the loss of precious compressed air/gas—ever.
